(19) United States
(12) Patent Application Publication
(10) Pub. No.: US 2024/0217891 A1
(43) Pub. Date: Jul. 4, 2024

(54) BIODEGRADABLE COATINGS, COATED PARTICLES, AND METHODS OF MAKING SAME

(71) Applicant: Pursell Agri-Tech, LLC, Sylacauga, AL (US)

(72) Inventor: Timothy Gene Holt, Florence, AL (US)

(73) Assignee: Pursell Agri-Tech, LLC, Sylacauga, AL (US)

(21) Appl. No.: 18/541,580

(22) Filed: Dec. 15, 2023

Related U.S. Application Data
(60) Provisional application No. 63/435,665, filed on Dec. 28, 2022.

(51) Int. Cl. C05G 5/30; C05C 5/04; C05C 9/00; C05F 11/08; C05G 3/40

(52) U.S. Cl. CPC C05G 5/38; C05C 5/04; C05C 9/005; C05F 11/08; C05G 3/40

(57) ABSTRACT

Biodegradable coatings, particles that are coated with such biodegradable coatings, and methods of making such coatings and coated particles. Coatings with urethane linkages, urea linkages, or a combination thereof may be degradable over time with a microbial powder or solution applied to the particle, between layers of the coating, or on top of the coating.

### CROSS-REFERENCE TO RELATED APPLICATIONS

This application claims priority to U.S. Provisional Patent Application No. 63/435,665, filed Dec. 28, 2022, the entire disclosure of which is incorporated by reference herein it is entirety.

### FIELD OF THE INVENTION

The present disclosure relates generally to coatings for particles that degrade over time. More specifically, the present disclosure relates to coatings and coated particles including such coatings that, when planted in soil or immersed in or floating on top of water, provide protection to the underlying particle and degrade once such protection is no longer desired or needed. In addition, the present disclosure relates to methods of making coatings and coated particles biodegradable with specially formulated microbial consortia impregnated into or applied thereon.

### BACKGROUND OF THE INVENTION

Many fertilizers are used in the form of particulate material and are water soluble, such as for example urea containing fertilizers. Such fertilizers may contain a core particle with a primary nutrient such as nitrogen (N), phosphorus (P) or potassium (K), or a combination of these elements. The primary nutrients are generally in forms that have excellent solubility in water, and so in damp or wet environments the primary nutrient may drain rapidly into the soil and migrate away from the plant before it can be taken up, or else may be rapidly degraded. In many cases, drainage or degradation leads to a loss of about 40 to about 60 percent of the fertilizer applied to crops. One way of improving the uptake of primary nutrients by the plant is to modify the fertilizer product to create sustained release from a controlled release fertilizer.

In this aspect, a controlled release fertilizer releases nutrient over time to match the nutrient requirement of the crop. One way to achieve a controlled released fertilizer is to apply a coating layer (typically a polymer coating layer). There are many types of controlled release polymer coated fertilizers used globally, e.g., sulfur-coated urea, polymer coated urea, and urea-formaldehyde products such as methylene urea. The advantages to using polyurethane coated controlled release fertilizers are many and include higher nutrient content, consistent and predictable nutrient release rates, and the flexibility to a variety of climates. As a result, in 2019, the demand for controlled release fertilizer in the world was estimated at 920 kilotons and the global market for controlled release fertilizer is projected to grow by more than 5 percent by 2026 from an estimated $2.4 Billion in 2021.

Similarly, there are current efforts to enhance agricultural approaches to growing crops. For example, agricultural manufacturers are exploring methods of applying protective coatings on seeds so that crops can be grown in a variety of geographical areas and/or be planted well in advance of the growing season. Since soil is the predominant receptor of these coated fertilizers and seeds, the empty coating shell of these products that remain in the soil at the end of their useful lives is a growing concern for the environment. Indeed, of the 359 million metric tons of global plastics production in 2018, 12.5 million metric tons were used in agricultural production annually, with coated fertilizers accounting for approximately 6.7 percent of this total.

While sustainable materials are an area of significant interest in agricultural product, efforts are still in the initial phases. For example, biodegradable polymers are being evaluated as a potential replacement for coated fertilizers. However, there are misconceptions about biodegradability that may prove limiting. In particular, there is a perception that, because a product is made of a biodegradable material, it will dematerialize regardless of the environment in which it is discarded. Rather, the environment that the material is exposed to plays a role in the rate of degradation and/or effectiveness. Indeed, there are certain environmental requirements, e.g., moisture level, sunlight exposure, soil and compost content, oxygen availability, and presence of microorganisms, that are essential to the biodegradation process. For example, biodegradation requires microorganisms to convert the broken down polymer molecules, i.e., the microplastics, into small molecules such as carbon dioxide, water, and organic matter. And, biodegradation of plastics becomes even more difficult if the microplastics reside in pond water, rivers, or streams where the species of microbes are much different than those found in soil.

Furthermore, while biodegradable plastics are typically used in processes that require injection molding, extruding, or pressing of the solidified polymer pellets into a rigid, semi-rigid, or flexible product, the physical characteristics associated with the use of biodegradable polymers offers many challenges when attempting to use these materials as coatings for fertilizer, seed, and other agricultural products. For example, biodegradable polymers typically possess a very high melting temperature that will damage or degrade the agricultural particle being coated. Moreover, if the underlying particle survives the coating process, any resulting coating is likely to be brittle, dusty, and fragile. Finally, a particle coated with the currently known biodegradable plastics will be less effective at controlling the release of the underlying particle when compared to conventional polyurethane-coated products.

Accordingly, there is a need for a coating solution that provides the same or improved level of protection and controlled release of an underlying agricultural particle, if applicable, as a conventional polyurethane coating, but can degrade after its useful life. The present disclosure provides such a coating solution, particles coated with such coating solutions, and methods of making such coatings and coated particles.

### SUMMARY OF THE INVENTION

The present disclosure relates to coating shell for agricultural particles such as fertilizer and seed that degrade. More specifically, the coating may incorporate a microbial consortium capable of degrading the polymer-based layer(s) of the coating shell. As a result, the polymer layers included in the coating will be reduced to carbon dioxide, water, and organic matter after the particle has delivered the nutrients to plants in a controlled manner (in the case of a fertilizer) or ruptured for germination (in the case of seed). This degradation is not compromised by the environment, i.e., each coated particle will contain a sufficient quantity of the microbial consortium to effectively degrade the polymer layer(s) regardless of whether the coated particle is in soil or water. In fact, the microbial consortium and polymer layer(s) are synergistic to the degradation process in that the polymer layer(s) protect the microbes from the environment while the microbes slowly release to the surfaces of the polymer. Without being bound by any particular theory, this slow-release allow the microbe colonies to multiply and replenish until all of the polymer has been degraded.

In some embodiments, the microbial consortium is added to the surface of uncoated particles prior to the application of one or more polymer layers. In other embodiments, the microbial consortium is incorporated between polymer layers where a first polymer layer is added to the surface of the uncoated particle. In still other embodiments, the microbial consortium is applied over the polymer layer(s).

In some aspects, the microbial consortium is applied onto a carrier powder. For example, the microbial consortium-including carrier powder may be applied to the surface of the uncoated particle, between polymer layers, or over the polymer layers. In other aspects, the microbial consortium may be in liquid form. For example, the microbial consortium-including liquid may be applied to the surface of the uncoated particle, between polymer layers, or over the polymer layers. This application may be accomplished by dipping, spraying, and the like.

The present disclosure also relates to a coated particle including: a core and a coating shell, wherein the coating shell includes: a first coating layer disposed on the core and including a coating formulation and a wax; a carrier powder impregnated with microbes, wherein the microbes are capable of degrading the coating formulation and wax, and wherein the carrier powder is applied to the first coating layer; and a second coating layer disposed on the carrier powder comprising the coating formulation. In some embodiments, the core includes a fertilizer. In other embodiments, the core includes a seed. In still other embodiments, the coating formulation includes polyurethane. In yet other embodiments, the coating shell further includes a third coating layer disposed between the first coating layer and the carrier power, and including the coating formulation and a wax; and a fourth coating layer disposed between the carrier powder and the second coating layer and including the coating formulation and a wax.

The present disclosure also relates to a coated particle including: a core; a carrier powder impregnated with microbes, wherein the carrier powder is applied to the core; and a coating shell including: a first coating layer including a coating formulation and a wax and disposed on the carrier powder; and a second coating layer including the coating formulation and disposed on the first coating layer, wherein the microbes are capable of degrading the coating formulation and wax. In some embodiments, the core includes a fertilizer. In other embodiments, the core includes a seed. In still other embodiments, the coating formulation includes polyurethane.

The present disclosure also relates to a coated particle including: a core; and a coating shell including: a first coating layer disposed on the core and including the coating formulation; and a carrier powder impregnated with microbes, wherein the microbes are capable of degrading the coating formulation and wax, and wherein the carrier powder is applied to the first coating layer. In some embodiments, the core includes a fertilizer. In other embodiments, the core includes a seed. In still other embodiments, the coating formulation includes polyurethane.

The present disclosure also relates to a coated particle including: a core; and a coating shell including: a coating layer disposed on the core and including a coating formulation, wherein the coating layer accounts for about 0.5 to about 5 percent of the total coated particle weight; and a solution comprising a microbial consortium disposed on the coating layer, wherein the microbial consortium is capable of degrading the coating formulation. In some embodiments, the core includes a fertilizer. In other embodiments, the core includes a seed. In still other embodiments, the coating formulation includes polyurethane.

The present disclosure also relates to a coated particle including: a core; and a coating shell including: a coating layer disposed on the core and including a coating formulation, wherein the coating layer accounts for about 0.5 to about 5 percent of the total coated particle weight; and a carrier powder impregnated with microbes, wherein the microbes are capable of degrading the coating formulation, and wherein the carrier powder is applied to the coating layer. In some embodiments, the core includes a fertilizer. In other embodiments, the core includes a seed. In still other embodiments, the coating formulation includes polyurethane.

### The Present Disclosure Also Relates to a Coated Particle Including:

a core; and
a coating shell including:
   a first coating layer disposed on the core including a coating formulation and a wax;
   a carrier impregnated with a microbial consortium, wherein the carrier is applied to the first coating layer in an amount of about 0.1 to about 1.0 percent by weight of the coated particle; and
   a second coating layer disposed on the carrier including the coating formulation, wherein the coated particle has a functionality period, and wherein the microbial consortium includes a plurality of microbes capable of substantially biodegrading the coating shell in a target period of time, wherein the target period time is about 48 months or less after the end of the functionality period.

In some aspects, the core includes a fertilizer. In other aspects, the core includes a seed. The coating formulation may include polyurethane. In some embodiments, the polyurethane is the reaction product of a polyisocyanate and a polyol. In other embodiments, the plurality of microbes includes a first set of microbes capable of degrading the coating formulation and a second set of microbes capable of degrading the wax. In some aspects, the plurality of microbes include least two or more microbes classified as Bio-Safety Level 1 organisms.

In still other embodiments, the coating shell further includes: a third coating layer disposed between the first coating layer and the carrier, and including the coating formulation and a wax; and a fourth coating layer disposed between the carrier and the second coating layer and including the coating formulation and a wax. In some aspects, the carrier may be a powder.

### The Present Disclosure is Also Related to a Coated Particle Including:

a core;
a carrier impregnated with a microbial consortium, wherein the carrier is applied to the core; and
a coating shell including:
   a first coating layer including a coating formulation and a wax and disposed on the carrier; and
   a second coating layer including the coating formulation and disposed on the first coating layer,
wherein the coated particle has a functionality period, and wherein the microbial consortium is capable of substantially degrading the coating shell in about 48 months or less after the end of the functionality period.

In some aspects, the core includes a fertilizer. In other aspects, the core includes a seed. The coating formulation may include polyurethane. In some embodiments, the microbial consortium includes a first set of microbes capable of degrading the coating formulation and a second set of microbes capable of degrading the wax. In other embodiments, the carrier is a powder.

### The Present Disclosure is Also Directed to a Coated Particle Including:

a core; and
a coating shell including:
   a first coating layer disposed on the core and including the coating formulation; and
   a carrier powder disposed on the first coating layer and impregnated with a microbial consortium, wherein the coated particle has a functionality period, wherein the microbial consortium includes a plurality of microbes capable of substantially degrading the coating shell in a target period of time, and wherein the target period of time is about 48 months or less after the end of the functionality period.

In some aspects, the core includes a fertilizer. In other aspects, the core includes a seed. In some embodiments, the coating formulation includes polyurethane. In other embodiments, the polyurethane is the reaction product of a polyisocyanate and a polyol. In yet other embodiments, the plurality of microbes include a first set of microbes capable of degrading the coating formulation and a second set of microbes capable of degrading the wax. In still other embodiments, the plurality of microbes include at least two microbes classified as Bio-Safety Level 1 organisms.

### BRIEF DESCRIPTION OF THE DRAWINGS

Further features and advantages can be ascertained from the following detailed description that is provided in connection with the drawings described below:

FIG. 1 is a cross-sectional view of a coated particle according to an embodiment of the present disclosure;

FIG. 2 is a cross-sectional view of a coated particle according to another embodiment of the present disclosure;

FIG. 3 is a cross-sectional view of a coated particle according to yet another embodiment of the present disclosure;

FIG. 4 is a graphical illustration of the biodegradation of the coating shell of a coated particle formed according to an embodiment of the present disclosure; and

FIG. 5 is a graphical illustration of the biodegradation of the coating shell of a coated particle formed according to another embodiment of the present disclosure.

### DETAILED DESCRIPTION

Unless otherwise defined, all terms (including technical and scientific terms) used herein have the same meaning as commonly understood by one of ordinary skill in the art of this disclosure. It will be further understood that terms, such as those defined in commonly used dictionaries, should be interpreted as having a meaning that is consistent with their meaning in the context of the specification and should not be interpreted in an idealized or overly formal sense unless expressly so defined herein. Well known functions or constructions may not be described in detail for brevity or clarity.

The terms “about” and “approximately” shall generally mean an acceptable degree of error or variation for the quantity measured given the nature or precision of the measurements. Numerical quantities given in this description are approximate unless stated otherwise, meaning that the term “about” or “approximately” can be inferred when not expressly stated.

The terminology used herein is for the purpose of describing particular embodiments only and is not intended to be limiting. As used herein, the singular forms “a”, “an” and “the” are intended to include the plural (i.e., “at least one”) forms as well, unless the context clearly indicates otherwise.

The terms “first”, “second”, and the like are used herein to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present disclosure.

Terms such as “at least one of A and B” should be understood to mean “only A, only B, or both A and B.” The same construction should be applied to longer lists (e.g., “at least one of A, B, and C”).

The term “consisting essentially of” means that, in addition to the recited elements, what is claimed may also contain other elements (steps, structures, ingredients, components, etc.) that do not adversely affect the operability of what is claimed for its intended purpose as stated in this disclosure. This term excludes such other elements that adversely affect the operability of what is claimed for its intended purpose as stated in this disclosure, even if such other elements might enhance the operability of what is claimed for some other purpose.

The term “over” as used herein refers to some layer, coating, or component, that is farther from the center of the particle than another. For example, “X is over Y” should be construed to mean that X is farther from the center of the particle than Y. X may be in direct contact with Y (“directly over”), or there may be an intervening distance/and or components. It is contemplated that any instance of the term “over” could be limited to “directly over.”

The present invention represents the combined capability for coated particles to be either slowly released (in the case of fertilizer and at a rate aligning with the requirement of the plant) or ruptured in a controlled fashion (in the case of seeds and at the appropriate germination time), and once released, the microbial consortium described herein, which is impregnated into, or on the surface of the coating, biodegrades the residual polymer layers of the coating shell. Moreover, in accordance with at least one embodiment, when the microbial consortium is protected by at least one polymer layer, microbes are slowly released to the surface for substantial degradation (as that term is discussed below) of the polymer layers of the coating shell. The slow-release of microbes ensures that the microbe colonies will continue to multiply and replenish until all of the polymer layer(s) of the coating shell has been substantially degraded.

### Underlying Particles

As discussed previously, the present disclosure pertains to coated particles where the coating is degradable over time. The underlying particle may be an agricultural particle. In some embodiments, the agricultural particle may be a granular fertilizer. In this aspect, the granular fertilizer may include a primary nutrient. The primary nutrient may be present in an amount of about 1 to about 99 weight percent based on the total weight of the coated particle. In one embodiment, the primary nutrient is present in an amount of about 1 to about 50 weight percent based on the total weight of the coated particle. In another embodiment, the primary nutrient is present in an amount of about 51 to about 99 weight percent based on the total weight of the coated particle.

The primary nutrient may include one or more nitrogen (N), phosphorus (P) and/or potassium (K) compounds. The nitrogen compounds may include, but are not limited to, urea, ammonium nitrate, ammonium sulphate, calcium nitrate, diammonium phosphate, monoammonium phosphate, potassium nitrate, sodium nitrate, and combinations thereof. The phosphorus compounds may include, but are not limited to, diammonium phosphate, monoammonium phosphate, monopotassium phosphate, dipotassium phosphate, tetra potassium pyrophosphate, potassium metaphosphate, single superphosphate, triple superphosphate, calcium phosphate, and combinations thereof. The potassium compounds may include, but are not limited to, potassium chloride, potassium nitrate, potassium sulfate, monopotassium phosphate, dipotassium phosphate, tetra potassium pyrophosphate, potassium metaphosphate, and combinations thereof.

In some embodiments, the N:P:K ratio may range from 10:0:4 to 30:15:25. For example, the N:P:K ratio may be 29:3:4, 22:7:10, 21:7:14, 20:5:10, 18:6:18, 16:4:8, 15:15:15, 13:13:13, 12:6:24, 10:10:10, 15:0:15, 15:5:10, 22:3:14, 20:28:5, or 12:6:6.

In other embodiments, the underlying particle also includes a secondary nutrient. In this aspect, the secondary nutrient may be included in an amount of about 0.5 to about 15 weight percent based on the total weight of the coated particle. For example, the secondary nutrient may be included in an amount of about 5 to about 10 weight percent based on the total weight of the particle. Secondary nutrients are not particularly limited. In one aspect, the secondary nutrient is calcium (Ca), magnesium (Mg), sulfur (S), or a combination thereof. Nonlimiting examples of calcium include calcium sulfate, calcium chloride, calcium carbonate, calcium silicate, calcium phosphate, and combinations thereof. Nonlimiting examples of magnesium include magnesium sulfate, magnesium chloride, magnesium oxide, magnesium carbonate, and combinations thereof. Nonlimiting examples of sulfur include elemental sulfur, a sulfate, e.g., ammonium sulfate, potassium sulfate, magnesium sulfate, calcium sulfate, and the like, and combinations thereof.

In still other embodiments, the underlying particle includes a micronutrient. In this aspect, micronutrients may be included in lower amounts than the primary nutrient or, if included, the secondary nutrient. In one embodiment, the micronutrient is included in an amount of about 0.01 to about 5.0 weight percent based on the total weight of the coated particle. In another embodiment, the micronutrient is included in an amount of about 0.1 to about 2.0 weight percent based on the total weight of the coated particle. Suitable micronutrients include, but are not limited to zinc (Zn), boron (B), iron (Fe), manganese (Mn), nickel (Ni), copper (Cu), molybdenum (Mo), chlorine (Cl), and combinations thereof. Zinc may be, for example in the form of one or more of zinc chelate, zinc chloride, zinc oxide, zinc sulfate, zinc oxy sulfate, and combinations thereof. Boron may be, for example, in the form of one or more of boric acid, sodium borate, sodium tetraborate, sodium octa borate, sodium metaborate, potassium borate, potassium tetraborate, potassium octa borate, potassium metaborate, and combinations thereof. Iron may be, for example, in the form of iron chelate, iron chloride, iron nitrate, iron oxalate, iron sulfate, and combinations thereof. Manganese may be, for example, in the form of one or more of manganese chelate, manganese chloride, manganese oxide, manganese sulfate, and combinations thereof. Nickel may be, for example, in the form of one or more of nickel chelate, nickel nitrate, nickel sulfate, and combinations thereof. Copper may be, for example, in the form of one or more of copper chelate, copper chloride, copper oxide, copper sulfate, and combinations thereof. Molybdenum may be, for example, in the form of one or more of ammonium molybdate, sodium molybdate, and the like. Chloride may be, for example, in the form of calcium chloride, copper chloride, iron chloride, magnesium chloride, manganese chloride, potassium chloride, zinc chloride, and combinations thereof. The form of the micronutrient is not particularly limited and may, for example, granules, crystals, powders, or as concentrated solutions, suspensions, colloids, slurries, pastes, or combinations thereof.

In other embodiments, the underlying particles may be any seed that is used to grow crops. In this aspect, suitable seeds include, but are not limited to such as soybean seeds, cottonseed seeds, sunflower seeds, canola seeds, corn seed, rapeseed seeds, peanut seeds, and other fruit and vegetables grown commercially. The seeds may also include wheat, barley, milo, alfalfa, sorghum, ceral, clover, fescue, timothy, oats, bermuda, bluegrass and rye.

The underlying particle to be coated may have a particle size of about 0.10 mm to about 25 mm, such as about 0.5 mm to about 20 mm, about 1 mm to about 15 mm, about 3 mm to about 10 mm, or about 5 mm to about 11 mm. In this aspect, at least about 80 percent of the underlying particle to be coated have an average particle size in the above-described ranges. In some aspects, the average size of the underlying particle is at least about 85 percent of the average size of the coated particles. In other aspect, the average size of the underlying particle is at least about 95 percent the average size of the coated particle. In still another aspect, the average size of the underlying particle is at least about 99.5 percent of the average size of the coated particle.

In some aspects, the average weight of the underlying particle is at least about 80 percent of the average weight of the coated particle. In other aspect, the average weight of the underlying particle is at least about 85 percent of the average weight of the coated particle. In still another aspect, the average weight of the underlying particle is at least about 90 percent of the average weight of the coated particle. In still another aspect, the average weight of the underlying particle is at least about 95 percent of the average weight of the coated particle. In still another aspect, the average weight of the underlying particle is at least about 98 percent of the average weight of the coated particle. In still another aspect, the average weight of the underlying particle is at least about 99 percent of the average weight of the coated particle.

### Coating Formulation

The coating may be formed from a coating formulation that includes one or more coating components. In one aspect, the coating is water impermeable. In another aspect, the coating is semipermeable and, once applied to an underlying particle, prevents the release of the underlying particle until needed. For example, when the underlying particle is fertilizer and the coating is semipermeable, both water and the fertilizer travel through the coating by diffusion.

In one embodiment, the coating component is a polymer. In another embodiment, the polymer(s) may be crosslinked. In this aspect, the polymer may be thermoset. In yet another embodiment, the polymer may be thermoplastic. A non-limiting example of a suitable polymer for use in forming the coating formulation is a water-insoluble polymer. In this aspect, the polymer may have a solubility of less than about 0.10 g/L in deionized water at 100 kPa and 20° C. For example, the solubility of the polymer may less than about 0.05 g/L in deionized water at 100 kPa and 20° C. In one embodiment, the polymer has a solubility of less than about 0.01 g/L in deionized water at 100 kPa and 20° C. In another embodiment, the polymer is not soluble at 20° C. in deionized water using the method outlined in D. Braun et al., Practical Macromolecular Organic Chemistry, CRC Press, 1984, p. 73 wherein 30-50 mg samples of finely divided polymer are placed in small test tubes with 1 ml liquid and allowed to stand for several hours. In some embodiments, the coating includes a resin. In this regard, the coating may include one or more polymers and/or one or more additives.

In one embodiment, the coating is a polyurethane coating. In this aspect, the number ratio of NCO to OH groups may range from 0.8:10 to 1.2:10. The components of such a polyurethane coating, i.e., the components that are added to the coating unit to form the coating around the particle components, include a polyisocyanate and a polyol. The polyisocyanate may have two or more isocyanate groups per molecule and may be aliphatic or aromatic. In one embodiment, the polyisocyanate is aromatic. In another embodiment, the polyisocyanate may be a diisocyanate with exactly two isocyanate groups. Non-limiting examples of suitable polyisocyanates for use in forming the coating formulation of the present disclosure include methylene diphenyl diisocyanate (MDI), such as 4,4′-MDI, toluene diisocyanate (TDI), and combinations thereof. An example of an aromatic polyisocyanate is a blend of polymeric and di-isomers of the isocyanate.

The polyol may have at least two hydroxyl groups per molecule, 2-5 hydroxyl groups, or 3-4 hydroxyl groups. The polyol may be based on a polyether, polyester, or natural oil. In one embodiment, the polyol is based on a polyether. In some embodiments, the polyol has a hydroxyl number of 150-700 and an average functionality of 3. In this aspect, a polypropylene polyol or polyethylene polyol with hydroxyl number 150-700 and functionality of 3 or 4 may be used, as these provide for relatively short chain lengths (e.g., molecular weight 300-700 Da) and may contribute to lower viscosity of the polyol. In one embodiment, the polyol has a viscosity of less than 2000 or less than 1000 mPa's at 25° C. and typically more than 100 mPa's at 25° C.

In other embodiments, the polyol is an aliphatic polyether polyol, such as a polyol formed from an initiator and a plurality of alkylene oxide units. The polyol may be initiated from a compound with 3 hydroxyl groups such as glycerol, amine-initiated, or a combination thereof. In still other embodiments, the polyol is a polyethylene oxide, a polypropylene oxide polyol, or other polyether polyol. Polyester polyols can also be used.

The polyol and polyisocyanate components may be selected such that the cure time is short, i.e., less than about 5 minutes at 25° C., at 70° C., and/or at the temperature the coating is applied, thereby allowing subsequent application of coating layers, if applicable, at intervals of less than about 5 minutes. The amount and type of catalyst can be adjusted accordingly for such cure time. In one embodiment, the polyol and polyisocyanate components are selected such that the cure time is less than about 2 minutes at 25° C., at 70° C., and/or at the temperature the coating is applied.

In some embodiments, the coating is a polyester coating, more preferably a thermoset polyester coating. In this aspect, the coating components can include an unsaturated polyester (include a carbon-carbon double bond) and a vinyl monomer. The reaction of these components can involve copolymerization of the vinyl monomer and the unsaturated polyester. The unsaturated polymer may be the reaction product of a saturated dicarboxylic acid (or anhydride), an unsaturated dicarboxylic acid (or anhydride) with a polyol, such as a diol (glycol). The glycol may be ethylene glycol, propylene glycol, 1,3-butylene glycol, hydrogenated bisphenol A, or a combination thereof. The glycol may be cyclic or acyclic and aliphatic or aromatic. The glycol may have 2-30 C atoms. The vinyl monomer may be styrene. The reaction between the components may involve copolymerization of the unsaturated polyester and vinyl monomer, in the presence of a free radical initiator and a catalyst. The unsaturated polyester may be injected as liquid mixture with the vinyl monomer, wherein the vinyl monomer also acts as solvent for the polyester.

In other embodiments, the coating is a polyurea coating and the coating components include a polyisocyanate and a polyamine. The polyisocyanate may be any of the polyisocyanates discussed above with respect the polyurethane coating and the polyamine may have two or more amine groups per molecule, preferably 2-5 amine groups, and more preferably 3-4 amine groups.

In still other embodiments, the coating is a hybrid polyurea-urethane or polyurethane-urea coating and the coating components include a polyisocyanate, a polyamine, and a polyol. The polyisocyanate, polyol, and polyamine may be any discussed above.

In yet other embodiment, the coating is a phenolic resin coating and the coating components include a phenol and formaldehyde. The phenol component and formaldehyde component can react in the coating unit to form a thermoset polymer.

In still other embodiments, the coating is an epoxy coating and the coating components include an epoxy component (having epoxide groups) and an optional co-reactant having reactive groups such as a amine, acids and acid anhydrides, phenols, alcohols and thiols. The co-reactant may have two or more of the reactive groups per molecule, to provide for the formation of a thermoset polymer. The epoxy component may crosslink through homopolymerization in the second step (discussed in more detail below) or by the reaction with the optional co-reactants.

In some aspects, the coating formulation may include initiators and/or catalysts, such as polymerization initiators (e.g., free radical initiators or cationic initiators) and polymerization catalysts (e.g., organometallic catalysts, tertiary amines, and organic or inorganic bases). The amount and type of catalyst can be adjusted accordingly for a desired cure time.

As discussed with respect to the polyurethane coating, the coating components for any suitable coating formulation discussed herein may be selected such that the cure time is less than about five minutes at 25° C., at 70° C., and/or at the temperature the coating is applied. If subsequent coating layers are applied (discussed in more detail below), the intervals between the coating layers may be about five minutes or less. In one embodiment, the coating components are selected such that the cure time is less than about 2 minutes at 25° C., at 70° C., and/or at the temperature the coating is applied.

The coating components may have a reactivity at room temperature of between about 10 and 300 seconds (time needed for at least 50 percent cure). In one embodiment, the reactivity of the coating components is about 10 seconds to about 150 seconds. For example, the reactivity of the coating components at room temperature may be about 10 seconds to about 60 seconds. In another embodiment, the coating components have a reaction time at 25° C. of about 30 to 250 seconds (wherein the reaction time is the time necessary for hardening). In another embodiment, the coating components have a reactivity of between about 10 and 60 seconds at the operating temperature of the coating unit and/or at 55º C. In still another embodiment, the coating components have a reactivity of between about 10 and 120 seconds at the operating temperature of the coating unit and/or at about 55° C. to about 70° C. In yet another embodiment, the coating components have a reactivity of between about 10 and 60 seconds at the operating temperature of the coating unit and/or at about 55° C. to about 70° C. For example, the reactivity of the coating components at operating temperature may be about 10 to 45 seconds. As mentioned above with respect to the use of catalysts, the reaction time can be achieved or adjusted by varying the amounts and types of catalysts used for the curing or hardening.

In addition, the coating formulation may include wetting agents, surfactants, biocides, herbicides, insecticides, fungicides, antistatic agents, micronutrients, plant growth or health promoting additives, or combinations thereof. Non-limiting examples of suitable micronutrients for use in accordance with the present disclosure include Fe, Mn, Zn, Cu, Mo, Ni, Cl, Mg, and B.

The coating formulation may include less than about 5 percent by weight water and/or organic solvents based on the total weight of the coating formulation. In this aspect, organic solvents may include organic compounds having a boiling point lower than 120° C. In some embodiments, the coating formulation includes less than about 4 percent by weight water and/or organic solvents based on the total weight of the coating formulation. In other embodiments, the coating formulation includes less than about 3 percent by weight water and/or organic solvents based on the total weight of the coating formulation. In still other embodiments, the coating formulation includes less than about 1 percent by weight water and/or organic solvents based on the total weight of the coating formulation. In yet other embodiments, the coating formulation includes less than about 5 percent, 4 percent, 3 percent, 2 percent, or 1 percent by weight water and/or organic solvents based on the weight of the uncoated particle.

In some aspects, the coating formulation and/or one or more of the components therein has a viscosity of less than about 2000 mPa's at 25º C (as measured according to ISO 3219:1993) when applied to the underlying particle. In one embodiment, the coating formulation and/or one or more of the components therein has a viscosity of less than about 1000 mPa's at 25° C. when applied to the underlying particle. In another embodiment, the coating formulation or one or more of the components therein have a viscosity of about 100 mPa's or more at 25° C. In yet another embodiment, the coating formulation or one or more of the components therein have a viscosity of about 500 mPa's or more at 25° C.

While the coating formulation can include additives as discussed, the coating formulation preferably includes less than about 40 percent by weight, less than about 30 percent by weight, less than about 20 percent by weight, or less than about 10 percent by weight (based on the total weight of the coating formulation) of components other than the reactants necessary for the chemical reaction to be carried out (as described in more detail below). In this aspect, should the coating formulation include wetting agents, surfactants, or the like, such additives may be present in the coating formulation in an amount of less than about 40 percent by weight based on the total weight of the coating formulation.

As briefly discussed above, the coating may be water-impermeable. In some aspects when the underlying particle is a seed, the coating protects the seed inside the coating from the environment until climatic conditions are sufficient to initiate seed germination at which time the coating ruptures and root and plant growth begins. In another embodiment, the coating is semipermeable (e.g., permeable for water and/or other solutes). When water enters through the coating due to osmosis, germination/swelling of the seed occurs, which can result in the coating cracking or bursting. In this aspect, sustained and/or delayed rupture of the coating material can be achieved. In fact, unlike when the underlying particle is a fertilizer (where the water penetrates the coating membrane allowing the fertilizer to turn into solution and be forced out of the pores of the coating), the coating on the finished coated seeds made in accordance with the present disclosure bursts once germination occurs because the underlying seed ruptures and roots start to form. As such, provided a coated seed is not subjected to climatic factors that define a growing season, it is contemplated that a coated seed made in accordance with the present disclosure will have not only an improved shelf life and a germination rate that is similar to or, in some cases, better than an uncoated seed. Moreover, while an uncoated seed may have to be landfilled after the initial growing season because the germination rate in the second growing season may be significantly less, i.e., only about 90 percent or less of the initial germination rate, a coated seed of the present disclosure not only has an initial germination rate that is comparable or better than the uncoated seed, the coated seeds also have a) a germination rate in the second growing season that is within about +5 percent of the initial germination rate and b) a shell that degrades after its useful life.

In some embodiments, the coating itself contains plant nutrients that assist in plant development. In other embodiments, the coating includes stimulating growth additives, stress reducing additives, or a combination there to assist in plant stress reduction. In still other embodiment, the coating includes plant nutrients and stimulating growth additives or stress reducing additives.

When the underlying particle is fertilizer, the thickness of the coating (after applied to the underlying particle) is about 1.0 μm to about 150 μm, 10 μm to about 100 μm, 20 μm to about 75 μm, 30 μm to about 50 μm in total and/or or per coating layer, although other thicknesses are also possible.

When the underlying particle is a seed, the thickness of the coating (after applied to the underlying particle) is about 1.0 μm to about 50 μm, in total and/or or per coating layer, although other thicknesses are also possible. In one embodiment, the thickness of the coating is about 5 μm to about 45 μm. In another embodiment, the thickness of the coating is about 10 μm to about 35 μm. In this aspect, the coating may include one or more layers, where each layer is formed form a coating formulation as described herein, and the coating formulation may be the same or different for each coating layer.

The coating, in total and/or or per coating layer, may be at least about 0.0010 percent by weight based on the total coated particle weight. In some aspects, the coating is about 0.10 percent to about 20 percent by weight based on the total coated particle weight. In other aspects, the coating is about 0.2 percent to about 15 percent by weight based on the total coated particle weight. In still other aspects, the coating is about 0.3 percent to about 10 percent by weight based on the total coated particle weight. In yet other aspects, the coating is about 1 percent to about 8 percent by weight based on the total coated particle weight. In still other aspects, the coating is about 0.2 percent to about 5 percent by weight based on the total coated particle weight. In some embodiments, the coating is about 0.3 percent to about 3 percent by weight based on the total coated particle weight. In other embodiments, the coating is about 0.5 percent to about 1.5 percent by weight based on the total coated particle weight.

In this aspect, a particle may have an initial coating that is about 0.5 to about 5 percent by weight based on the total coated particle weight merely for storage purposes, blending compatibility, or a combination thereof. For example, a coating of this weight may be useful to increase the stability of an uncoated seed so as to allow a coated seed to potentially be planted in the second growing season (rather than the first or initial growing season) with the same or substantially the same germination rate as if it had been planted in the first growing season. In this regard, coated seeds may also be subjected to an additional coating process at a later time to add to the coating weight to improve or maintain the germination rate if planted outside of the normal growing season. For instance, a coated seed with a 1-2 percent by weight (based on the total coated seed weight) may be coated again to add further protection or insulation from extreme weather conditions, destructive insects, and/or moisture. As such, the coated particle may be subjected to (i) a first coating process at a first time to provide a first coating or layer with a first weight and (ii) a second coating process at a second time to provide a second coating or layer with a second weight.

### Method of Making Carrier Powder

As briefly discussed above, before, during, or after the polymer coating layers are in place, a pre-determined amount of microbial consortium-including carrier powder is added in a vegetative state or spore form to the product. The carrier powder, microbial consortium, and method of making an microbial consortium including carrier powder are discussed in this section.

The carrier powder may include, but is not limited to, agar, bone meal, calcium carbonate, calcium oxide, calcium hydroxide, calcium phosphate, calcium silicate, calcium stearate, carbon black, cocoa shell mill, dextrose, diatomaceous earth, dolomite, fuller's earth, kaolin clay, magnesium ammonium phosphate, magnesium oxide, magnesium silicate, magnesium stearate, montmorillonite, perlite, phosphate rock, potassium alginate, poultry ash, rice hull ash, sawdust, silica, sodium alginate, sucrose, talc, vermiculite, zinc oxide, zinc stearate, zeolite, and combinations thereof. The mean particle size of the carrier powder may be in the range of about 0.1 to about 150 μm. In one embodiment, the mean particle size of the carrier powder may be in the range of about 0.5 to about 100 μm. In another embodiment, the mean particle size of the carrier powder may be in the range of about 1 to about 50 μm.

The microbial consortium includes polymer coating degrading microbes. In general, the microbial consortia or co-cultures are the combinations of various microorganisms that can degrade several types of polymeric materials with greater biodegradation potential when compared to the applications of individual isolates in ideal environmental conditions. For example, without being bound to any particular theory, several microorganisms can effectively degrade various types of plastic polymers in the form of consortia/co-cultures at a faster rate in comparison with their applications as pure cultures.

In some aspects, the consortium may include one or more of the following bacteria degrading microbes: Acinetobacter calcoaceticus, Acinetobacter germeri P7, Alicycliphilus sp. BQ1, Alicycliphilus sp. BQ8, Arthrobacter sp., Arthrobacter calcoaceticus ATCC 31012, Arthrobacter calcoaceticus NAV-2, Arthrobacter globiformis, Bacillus sp., Bacillus pumilus NMSN-1d, Bacillus subtilis, Chryseobacterium meningosepticum, Comamonas acidovorans TB-35, Corynebacterium sp., Delftia acidovorans TB-35, Enterobacter agglomerans, Micrococcus sp., Pseudomonas sp., Pseudomonas aeruginosa, Pseudomonas aeruginosa, Pseudomonas aeruginosa ATCC 13388, Pseudomonas aeruginosa ATCC 9027, Pseudomonas aeruginosa MTCC 7814, Pseudomonas aeruginosa MZA-85, Pseudomonas aeruginosa NAV-6, Pseudomonas cepacian, Pseudomonas chlororaphis, Pseudomonas chlororaphis ATCC 55729, Pseudomonas fluorescens, Pseudomonas proegens Pf-5, Pseudomonas putida, Pseudomonas putida ATCC 17484, and Serratia rubidaea. Without being bound by any particular theory, such bacteria degrading microbes degrade polyester-based polyurethane via enzymatic hydrolysis. In some aspects, the consortium may include one or more of the following bacteria degrading microbes: Rhodococcus equi TB-60, Staphylococcus epidermidis, Exophiala jeanselmei REN-11A, Bacillus amyloliquefaciens, Comamonas acidovorans TB-35, Escherichia coli, Micrococcus sp., Pseudomonas fluorescens, Pseudomonas protegens Pf-5, Staphylococcus aureus, Staphylococcus epidermidis, and Staphylococcus epidermidis strain KH 11. Without being bound by any particular theory, such bacteria degrading microbes degrade polyether-based polyurethane via enzymatic hydrolysis.

In still other aspects, the consortium may include one or more of the following fungi degrading microbes: Alternaria sp., Alternaria Solani Number Ss.1-3, Alternaria sp. strain PURDK2, Alternaria tenuissima, Aspergillus flavus, Aspergillus fumigatus, Aspergillus niger, Aspergillus niger ATCC 9642, Aspergillus section flavi, Aspergillus terreus, Aspergillus tubingensis, Aspergillus versicolor, Aureobasidium pullulans, Bionectria sp. E2910B, Chaetomium globosum, Cladosporium sp., Cladosporium asperulatum, Cladosporium ontecillanum, Cladosporium pseudocladosporioides, Cladosporium tenuissimum, Cryptococcus laurentii, Curvularia senegalensis, Fusarium solani, Gliocladium roseum, Lasiodiplodia sp. E2611A, Penicillium chrysogenum, Penicillium funiculosum, Penicillium section lanata-divaricata, Pestalotiopsis microspore E33/7A, Pestalotiopsis microspore E27/2A, Pleosporales sp. E28/2A, or Trichoderma sp. Without being bound by any particular theory, such fungi degrading microbes degrade polyester-based polyurethane via enzymatic hydrolysis.

In yet other aspects, the consortium may include one or more of the following fungi degrading microbes: Alternaria sp. strain PURDK2, Alternaria tenuissima, Aspergillus flavus, Aspergillus fumigatus, Aspergillus niger, Aspergillus versicolor, Aureobasidium pullulans, Chaetomium globosum, Cladosporium sp., Cladosporium tenuissimum, Cladosporium asperulatum, Cladosporium herbarum, Cladosporium montecillanum, Cladosporium pseudocladosporioides, Exophiala jeanselmei REN-11A, Penicillium chrysogenum, Penicillium funiculosum, Trichoderma sp. Without being bound by any particular theory, such fungi degrading microbes degrade polyether-based polyurethane via enzymatic hydrolysis.

In still other aspects, the consortium may include one or more of the following enzymes: Basillus sp. Protease, Bacillus subtilis esterase, Bromelain, Candida antarctica lipase, Candida cylindracea lipase, Cathepsin C, Cholesterol esterase, Chymotrypsin, Collagenase, Comamonas acidovorans TB-35 esterase, Curvularia senegalensis esterase, Esterase, Ficin, Fungal peroxidase, Human neutrophil elastase, Laccase, Leucine aminopeptidase, Lipase, Lipase AK, Lipase PS, Lipolase 100L, Novozym 51,032, Novozym 735, Palatase 20,000, Papain, Porcine liver esterase, Protease K, Pseudomonas cepacia lipase, Pseudomonas fluorescens esterase, Pseudomonas sp. Lipase, PueA (Pseudomonas chloroaphis lipase), PueB (Pseudomonas chloroaphis lipase), Rhizopus arrhizus lipase, Rhizopus delemar lipase, Tcur0390 (Thermomonospora curvata DSM43183 hydrolase), Tcur1278 Thermomonospora curvata DSM43186 hydrolase), Thermomyces lanuginosus lipase, and Urease. Without being bound by any particular theory, such enzymes degrade polyester-based polyurethane via enzymatic hydrolysis.

In other aspects, the consortium may include one or more of the following enzymes: Lipase AK, Pseudomonas cepacia lipase, Thermomyces lanuginosus lipase, Esterase, Porcine pancreas lipase, Cholesterol esterase, Leucine aminopeptidase, Cathepsin C, Chymotrypsin, Porcine pancreatic elastase, Papain, Ficin, Human neutrophil elastase, Collagenase, and Urease.

Without being bound by any particular theory, such enzymes degrade polyether-based polyurethane via enzymatic hydrolysis.

In one embodiment, the consortium includes two or more microbes classified as Bio-Safety Level 1 (BSL-1) organisms. As would be understood by those of ordinary skill in the art, a BSL-1 has specific controls for containment of microbes and biological agents that are determined by, among other things, infectivity, severity of disease, transmissibility, and the nature of the work conducted. In this aspect, a microbe classified as a BSL-1 organism is not known to consistently cause disease in healthy adults and presents minimal potential hazard to laboratorians and the environment. Non-limiting examples of microbes classified as a BSL-1 organism include Escherichia coli, Pseudomonas fluorescens, Staphylococcus epidermidis, and Aspergillus niger. In another embodiment, the consortium includes two or more microbes classified as BSL-1 organisms that are capable of degrading ether-based polyurethane, ester-based polyurethane, and combinations thereof via enzymatic hydrolysis.

In some instances, the two or more species are in physical contact with one another. In some aspects, the microbes in the consortium may affect one another by direct physical contact or through biochemical interactions, or both. For example, the microbes in the consortium may exchange nutrients, metabolites, or gases with one another. In this aspect, at least some of the microbes in the consortium may be metabolically interdependent.

In this aspect, a variety of specially selected microbes may be combined to form a microbial consortium of the present disclosure where the microbes are compatible, co-exist, and thrive as they work together to biodegrade the residual coating shells of the coated particle. The microbial consortium presents no health risk to humans, animals, plants, or the environment. In some embodiments, the microbial consortium includes a first set of microbes selected to biodegrade the residual coating shells and a second set of microbes selected to biodegrade the wax-based sealant. For example, the microbial consortium may include a first set of bacteria degrading microbes that are capable of degrading the polymer coating and a second set of microbes that are capable of degrading the wax-based sealant. In some embodiments, the microbial consortium may include a first set of microbes including at least two of Escherichia coli, Pseudomonas fluorescens, Staphylococcus epidermidis, and Aspergillus niger and a second set of microbes capable of degrading the wax-based sealant.

The microbes use the polymer and wax compounds as a source of energy for their growth by secreting extracellular enzymes. The polymers are then depolymerized by these enzymes (and biodegraded). In other words, biodegradation of residual coating shells generally include three steps: (a) microorganism attachment on the surface of the polymer, (b) utilization of the specific polymer as a source of energy, and (c) polymer degradation. Without being bound by any particular theory, the fact that these microbes do not have to compete to survive, but rather co-exist to convert the polymer in the residual coating shell to carbon dioxide, water, and organic matter, is essential to the biodegradation process of the present disclosure.

In some embodiments, the microbial consortium is included in a liquid medium (such as a storage, culture, or fermentation medium), for example, as a suspension in the liquid medium. In this aspect, the concentration of each species in the microbial consortium may range from about 1.0×10⁵ CFU per gram to about 1×10¹⁰ CFU per gram. In other embodiments, the microbial consortium is included on the surface of or embedded in a solid or gelatinous medium (including but not limited to a culture plate), or a slurry or paste.

There are several process techniques that may be utilized to impregnate the microbial consortium solution onto a carrier powder. The concentration of the microbial consortium (i.e., the total count of microbes in the carrier powder may range from about 1.0×10¹¹ CFU per gram to about 1.0×10¹⁵ CFU per gram. The ratio of carrier powder to microbial consortium (percent) may range from 90:10 to 99:1. For example, in some embodiments, the microbe-containing carrier includes about 90 to about 99.9 percent carrier powder and about 0.1 to about 10 percent microbial consortium. In one aspect, the microbe-containing carrier includes about 95 to about 98 percent carrier powder and about 5 to about 2 percent microbial consortium. In another aspect, the microbe-containing carrier includes about 99 to about 99.5 percent carrier powder and about 1 to about 0.5 percent microbial consortium. In still another aspect, the microbe-containing carrier includes about 90 to about 95 percent carrier powder and about 10 to about 5 percent microbial consortium. In yet another aspect, the microbe-containing carrier includes about 95 to about 99.5 percent carrier powder and about 5 to about 0.1 percent microbial consortium.

In some aspects, producing a dry microbe-containing carrier that is fully functional depends on the process used to remove the water. Also, since the microbes are sensitive to heat, the temperature range may be between about 0° C. and 60° C. (to minimize damage of the microbes in a vegetative state). And, as would be understood by those of ordinary skill in the art, the temperature limitations/ranges for microbes in spore form are species dependent. Indeed, for microbes that are processed in a dormant spore form, the temperature limitation can have a much broader range. Generally, spores are resistant to approximately 40-45° C. higher temperatures than their corresponding vegetative state, increasing the spore heat tolerance up to 10⁵-fold.

One or more drying technologies can be used to dry the carrier powder once the microbial consortium solution is applied. For example, a filtration process, decantation process, ambient air drying, low heat and high airflow exposure, centrifugal separation, vacuum drying, and/or freeze drying may be used to dry the microbial consortium including carrier powder before use.

In one embodiment, a fluidized bed drying process is used to produce the microbial consortium including carrier powder. In this aspect, the fluid bed system may include a blower and a fluidizing gas filtration system, a fluidizing gas heater, a lower plenum, a fluidizing chamber equipped with a gas distribution plate and liquid spray nozzle, an expansion chamber, an upper plenum equipped with filtration, and an exhaust blower. An air or alternative gas stream may be filtered, preheated, and introduced into the lower plenum of the fluid bed. The gas distribution plate, located at the base of the fluidizing chamber, distributes the air evenly through the bed of carrier particles. Generally, as the particles are suspended in the gas stream, liquid is pumped to the spray nozzle using a fluid metering system. The spray nozzle atomizes the liquid into small droplets. The small droplets contact the fluidizing particles and are absorbed or collect on the surface of the fluidizing carrier powder. The suspended particles containing liquid continue to fluidize until evaporation occurs. The fluidizing gas and water vapor pass through the expansion chamber, filtration system, and exit the fluid bed through the exhaust blower. At the completion of this cycle, dry carrier particles containing the microbes are discharged from the fluid bed and are set aside or packaged for future use.

The operating conditions of a fluid bed are generally dictated by the properties of the fluidized solid that will serve as the carrier. The carrier powder particle size, bulk density, and fluidization velocity are a few of the properties that influence the design and operation of a fluid bed. Other process considerations involve the amount of water to be evaporated when the microbial consortia solution is applied to the carrier powder. The fluidizing air temperature and gas velocity are two important factors that dictate the rate of drying.

In some embodiments, the process includes a bed of carrier powder particles being suspended in a controlled amount of preheated fluidizing gas that is directed through a perforated gas distribution plate. As the powder and fluidizing gas uniformly mix, the carrier powder particles are lifted in the gas stream, the bed volume expands considerably, and the carrier powder particles behave as a liquid. As the carrier powder particles reach a steady state of fluidization in the heated gas stream, the microbial consortium solution is sprayed onto the fluidizing bed of carrier powder particles. The spray droplets of the microbial consortium solution remain liquid as they are applied to the surface of the fluidizing carrier powder particles. The microbes are absorbed into and on the surface of the fluidizing carrier powder particles. As the particles continue fluidizing in the heated gas stream, evaporation of the liquid occurs, and the dried carrier powder now contains the polymer-degrading microbes.

### Method of Making Coated Particles

In the first step of the method, the particles are fed into a coating unit. In some embodiments, the coating unit is a high-speed mixer/coater that includes a rotating pan and a rotor, wherein the speed of the rotating pan and the speed and direction of the rotor can be controlled independently. Suitable mixers/coaters are supplied, for example, by Eirich. Such coating units facilitate rapid mixing of particles and promote particle to particle surface contact so as to allow for uniform coverage of the coating formulation. In addition, high-speed agitation may allow for the addition of several layers of coating to be applied in a short period of time. The mixer/coater may be operated in a batch or batch continuous mode with the use of multiple units.

In some embodiments, the particles may be screened to a desired particle size before being introduced into the coating unit. In other embodiments, the particles may be pre-heated before feeding into the coating unit. In this aspect, the particles may be pre-heated to a temperature of at least about 30° C., at least about 40° C., at least about 50° C., at least about 60° C., or at least about 70° C. In other aspects, the particles may be pre-heated before feeding into the coating unit to a temperature of about 5° C. to about 50° C. above ambient temperature. For example, the particles may be pre-heated to a temperature of about 15° C. to about 40° C. In one embodiment, the particles are pre-heated to a temperature of about 20° C. to about 30° C. In still other aspects, the particles may be pre-heated to a temperature of about 15° C. to about 60ºC. In one embodiment, the particles are pre-heated to a temperature of about 20° C. to about 80° C.

The particles may be fed into the coating unit in an amount of more than about 10 percent, more than about 20 percent, more than about 40 percent, or more than about 60 percent, and/or less than about 95 percent, less than about 90 percent, less than about 80 percent, of the volume of the interior space of the coating unit (based on the bulk density of the seed components). In one embodiment, the particles are fed into the coating unit in an amount of about 60 percent to about 90 percent of the volume of the interior space of the coating unit. In another embodiment, the particles are fed into the coating unit in an amount of about 75 percent to about 90 percent of the volume of the interior space of the coating unit. The volume fraction based on bulk density means that a bulk bed of the uncoated particles (including void space in the bed) occupies the volume fraction of the interior space. Without being bound to any particular theory, this range of filling fractions can contribute to the formation of a lifted bed and to good distribution of the coating components.

Once the coating unit has been charged with the particles, the component(s) of the coating formulation may be added to and allowed to react in the coating unit in the second step of the method. This second step may be carried out (and completed) in about 10 to about 600 seconds. In one embodiment, the second step is carried out in about 30 to about 240 seconds. For example, the second step may be carried out in about 30 to about 120 seconds or about 30 to about 90 seconds. In another embodiment, the second step is carried out in about 10 to about 120 seconds. For example, the second step may be carried out in about 10 to about 60 seconds or about 10 to about 30 seconds. In some embodiments, the coating component(s) is (are) added to the coating unit and, more specifically one of the movable elements in about 0.5 to about 30 seconds, about 1 to about 10 seconds, or about 1 to about 5 seconds. In other embodiments, the coating component(s) is (are) distributed over the particles (i.e., mixed with the particles) in about 5 to about 45 seconds or about 10 to about 30 seconds.

While this second step of the method is directed to the application of one coating layer, the step of applying a coating layer can be performed one or more times to provide coated particles having one or more coating layers. Also, other compounds and layers, e.g., solvents and wax layers, can be applied simultaneously or subsequently along with the coating application step if desired. For example, at least two coating layers (having the same or different coating formulations) may be applied stepwise. If this second step is performed two or more times to provide more than one coating layer in the coated particles, these times refer to one instance of the second step. In one embodiment, step b) involves applying two or more coating components subsequently and stepwise to the seed particles while both the container and the rotor are rotating. In another embodiment, the coating component added first to the particles has a higher molecular weight (such as number average molecular weight) and/or higher viscosity than the second coating component. In still another embodiment, the first coating component is added to the particles and mixed for 2-120 seconds, such as 10-60 seconds, and then the second coating component is added. The mixing of the first coating component may provide for a homogeneous distribution of the coating component over the particles at the end of the mixing period and before the second coating component is added. In some aspects, both coating components are injected as liquids (which can include dripping and spraying) and, preferably, to a bed of lifted particles. In one embodiment, the bed of lifted particles contains a zone wherein the particles move the fastest (e.g. close to the rotor) and the coating component is added to that part. This may provide for achieving even distribution of the coating component over the particles quickly.

In some embodiments, the first two coating components that are added are reactive with each other. After the one or more reactive coating components are applied, the method may involve allowing the coating components to react. with each other for instance for a period of 10 to 300 seconds, such as 10 to 120 seconds, while the particles are kept in motion. An advantage of the coating method of the present disclosure is that this reaction carried out in the coating unit may provide for curing or hardening of the particles without agglomeration of the coated particles. Another advantage of the coating method of present disclosure is that this reaction carried out in the coating unit may provide for curing or hardening of the particles at a lower temperature than other similar technologies which ensure that the added polymer degrading microbes will survive.

The coating formulation(s) may be applied as a liquid. In this aspect, the liquid may be in the form of an emulsion, solution, or a dispersion. In other embodiments, the coating formulation may be applied as a polymer melt, e.g., at a temperature sufficiently above the glass transition temperature of the polymer such that the polymer has sufficiently low viscosity.

The first and second steps of the method may be carried out at a temperature ranging from about 10° C. to about 120° C. In one embodiment, the first and second steps of the method are carried out at a temperature of at least about 10° C., at least about 30° C., at least about 40° C., at least about 50° C., at least about 55º C, at least about 60º C or at least about 70° C. In another embodiment, the first and second steps of the method are carried out at a temperature of less than about 120° C. or less than about 80° C. For example, the first and second steps of the method may be carried out at a temperature range of about 40° C. to about 120° C., about 50° C. to about 100° C., or about 55° C. to about 75° C.

The third step of the method also involves at least partially curing or hardening the one or more coating layers. The curing or hardening step involves chemical reaction of the one or more components in the coating formulation while in the coating unit. The coated particles are kept in motion during curing. The chemical reaction may provide for the polymerization and/or cross-linking of polymers, an increase in the viscosity of the coating layer, or both. In this regard, the chemical reaction may involve crosslinking to form a thermoset polymer or may not involve crosslinking to form a thermoplastic polymer. Moreover, when the coating formulation is formed from only one reactant/component, the component reacts with itself, e.g., in a polymerization reaction. As discussed previously, initiators and/or catalysts may be used to effect curing or hardening. In one embodiment, the third step is carried out (and completed) in about 60 seconds to about 10 minutes. For example, the third step may be carried out in about 2 to about 8 minutes. In another embodiment, the third step is carried out in about 1 minute to about 6 minutes. Depending on the degree of cure, further curing or hardening may be carried out subsequent to the third step, i.e., in a fourth step, before and/or after discharge of coated particles from the coating unit. The optional final curing or hardening step is applied to bring the coated particles in condition for discharge, e.g., non-sticky and with sufficient mechanical/crushing strength to be handled, packaged, and stored. A final hardening step may include evaporation of unreacted monomer, or cooling, and/or a final hardening chemical reaction step. A final cure step may include allowing the coating components present in the applied coating layers to further react (with or without initiators or catalysts). In this aspect, the final curing step may involve crosslinking of polymeric coating material. In one embodiment, the final curing or hardening step is carried out in the same or different coating unit as used for the second and/or third steps of the method.

In one embodiment, the fourth step is carried out (and completed) in about 1 minute to about 15 minutes. For example, the fourth step may be carried out in about 2 to about 12 minutes. In another embodiment, the fourth step is carried out in about 1 minute to about 8 minutes. In still another embodiment, the fourth step is carried out in about 2 to about 5 minutes.

The residence time in the coating unit may be about 30 minutes or less. In one embodiment, the residence time is about 20 minutes or less. In a second embodiment, the residence time is about 15 minutes or less. In another embodiment, the residence time is about 10 minutes or less. In still another embodiment, the residence time ins about 5 minutes or less.

If additional components are used, e.g., wetting agents, surfactants, or the like, as discussed above, such components may be added to the coating unit in the second step with the other components in the coating formulation, or in the third step, i.e., the curing or hardening step.

The coating can include wax, which may be applied as a layer between coating layers that are cured or hardened during the third step and/or as final layer. The wax may be an olefin wax. In one embodiment, the wax is an alpha-olefin wax with at least 20 carbon atoms. In another embodiment, the wax is an alpha-olefin wax with at least 30 carbon atoms. In this aspect, the wax may be a hydrocarbon (such as alkane) 20 to 40 carbon atoms. The wax may also be a paraffin wax, a petrolatum wax, a polyamide wax, or a combination thereof. In one embodiment, the wax is a microcrystalline wax. Accordingly, suitable waxes may include, but are not limited to Evacote® from The International Group, Inc., Alpha Olefin® C30+, Alpha Olefin® C30+HA, Neodene26+ Alpha Olefin Wax, Neodene 2024 Alpha C20-22 Linear Olefin, polyethylene/bright stock oil mixtures, animal fat-based waxes, and hydrogenated oils, and similar materials.

The microbe-containing carrier may be applied to the particles while the particles are in the coating unit. In this regard, the carrier powder can be applied before, after, or during coating with polymer or wax layers. Indeed, the carrier powder may be added between polymer or wax coatings or can be combined with a coating material of the wax or polymer layers, for example by mixing or premixing into the polyol or isocyanate material. For the sake of clarity, when the carrier powder is added between polymer or wax coatings, it may adhere to those layers and, thus, the carrier powder is not necessarily considered or always shown as a separate layer herein. The coating step may therefore include adding the microbial consortium including carrier powder before, during or after application of at least one coating of polyol or isocyanate.

The method also includes discharging the coated particles from the coating unit. In one embodiment, the coated particles are at least about 70° C. when discharged from the coating unit. After being discharged, the coated particles may be subjected to additional steps including, but not limited to, a cooling step, a packaging step, a metering step, a storage step, or a combination thereof. For example, the coated particles may be cooled from the exit temperature (e.g., about 70° C. or higher) to about 30° C. or lower. In this aspect, the cooling step may include suspending the coated particles in cooling air. The packaging step may include packaging the coated particles in bags or containers. The metering step may involve dividing a stream of coated particles in batches of a metered amount so that batches may be transferred to a desired mode of transportation (with or without packaging).

The coating method described herein may be carried out as batch process or as continuous process. For example, a batch process may be used to produce coated particles with multiple coating layers, i.e., wherein two or more steps of applying a coating layer are carried out in the same coating unit. In addition, for a batch process, the one or more components of the coating formulation may be added continuously over a time of about 10 seconds or more. Two or more batch coating units may be operated in parallel, with the parallel coating units carrying out different steps from each other at the same time. In such an embodiment, the method of the present disclosure may be carried out in a batch-continuous or semi-continuous mode. In this aspect, the method may involve charging a first coating unit with particles and applying the coating layer(s) and carrier powder while a second coating unit carries out a different step. In such an embodiment, the method may involve applying the total number of coating layers to be applied on the particles (e.g., 1, 2, 3, or more layers) and the carrier powder in one of the parallel coating units. In one embodiment, the method is carried out as a continuous process such that two or more coating layers are applied in different coating units arranged in series, and the partially coated particles are transported from a first coating unit after application of a first coating layer to a second coating unit for an application of the carrier powder and second series of coating layers. Transporting may be accomplished with a moving belt, or coating units may be placed on top of each other such that transporting is carried out by gravity. The continuous process may involve continuous supply of particles to a first coating unit and transfer of partially coated particles (i.e., particles having a coating layer from the first coating unit to a downstream second coating unit and withdrawal of partially coated particles having an additional coating layer from the second coating unit). In other embodiments, two or more coating units as described are used in series, wherein different coating layers are applied stepwise in different coating units, and wherein the transportation involves transporting batches of coated particles at least from a first coating unit to a downstream second coating unit.

In such embodiments, the coating unit may include a plurality of coating devices, arranged in series or in parallel, wherein each coating device includes a container and at least one rotor. For example, the coating unit may include a plurality of coating devices, arranged in series and connected with each other with transport lines for coated or partially coated particles (such as moving belts or ducts), wherein each coating device has one container. Each container has for instance an inlet and outlet for coated particles. In another embodiment, a coating system is used with a plurality of coating units in parallel, and with a common cooling stage downstream of the coating units.

In a non-limiting example, the coating unit includes a container and a rotor as the two movable elements, the coating is a polyurethane coating, and the second step includes subsequently (after each other, but optionally with further steps before, in between, and/or after) and the addition of the carrier powder:
1) injecting a polyol into a bed of particles in the container, where the granules in the bed may be lifted by the motion of the container and the rotor, and where the injecting may be with an open pipe or with a spray nozzle;
2) mixing the polyol with the particles for about 5 to about 120 seconds, preferably about 10 to about 60 seconds;
3) injecting a polyisocyanate component into the bed of particles in the container, where the injecting may be with an open pipe or a spray nozzle;
4) rolling the particles in the container for at least about 10 to about 300 seconds, preferably about 20 to about 180 seconds, which allows the polyol and the polyisocyanate components to react with each other and to at least partially cure the coating layer;
5) injecting a molten wax sealant into the bed of coated particles using an open pipe;
6) metering a pre-determined amount of carrier powder; and
7) repeating process steps 1-5.

In one embodiment, the step of injecting the coating components may be reversed, i.e., the step of injecting a polyisocyanate component may occur before the steps of injecting and mixing the polyol. Of course, other coating components may be substituted for the polyol and/or polyisocyanate to provide a coating formed from any of the other suitable coatings discussed above. In the rolling step, the coating unit and its movable elements may be rotated or otherwise manipulated to effect rolling of the particles.

Because the microbial consortium-including carrier powder is applied to each coated particle, the microbes are both protected by the coating shell and also are slowly released to the surfaces of the plastic to degrade the coating shell. Indeed, the method of the present disclosure produces ensures that the microbes in the microbial consortium will continue to multiply and replenish until all of the polymer has been degraded. In fact, the process of polymer degradation will not take place until the environmental conditions are in alignment with promoting microbial activity and reproduction. Moreover, since the microbial consortium-including carrier powder is applied to each coated particle, there is no dependency on specific types or concentration of microbes present in the environment—soil or water—for biodegradation of the polymer coating shell to occur.

As such, each coated particle contains a pre-determined concentration of microbes sufficient to substantially biodegrade the polymer coating in a period of time. In some aspects, “substantially biodegrade” means that less than about 10 percent of the residual coating shell remains after a target period of time (as that term is defined below to begin after the end of the functionality period of the coated particle). In other words, more than about 90 percent of the organic carbon in the polymer coating is converted into carbon dioxide in the target period of time. In some embodiments, less than about 5 percent of the residual coating shell remains after a target period of time and/or more than about 95 percent of the organic carbon in the polymer coating is converted into carbon dioxide in the target period of time. In other embodiments, less than about 3 percent of the residual coating shell remains after a target period of time and/or more than about 97 percent of the organic carbon in the polymer coating is converted into carbon dioxide in the target period of time. In still other embodiments, less than about 1 percent of the residual coating shell remains after a target period of time and/or more than about 99 percent of the organic carbon in the polymer coating is converted into carbon dioxide in the target period of time. In still other embodiments, less than about 0.1 percent of the residual coating shell remains after a target period time and/or more than about 99.1 percent of the organic carbon in the polymer coating is converted into carbon dioxide in the target period of time. In this regard, the polymer coating ultimately decomposes into carbon dioxide, biomass, and water.

In some embodiments, the target period of time is about 48 months or less after the end of the functionality period of the coated particle. For example, if the functionality period of the coated particle, i.e., the length of time required for a coated particle to release the intended nutrients, is about 12 months, the total period of time until the coated particle substantially biodegrades is about 60 months. In other embodiments, the target period of time is about 36 months or less after the end of the functionality period of the coated particle. In yet other embodiments, the target period of time is about 24 months or less after the end of the functionality period of the coated particle. In still other embodiments, the target period of time is about 16 months or less after the end of the functionality period of the coated particle. In other embodiments, the target period of time is about 12 months or less after the end of the functionality period of the coated particle.

In this aspect, the target period of time may range from about 1 month to about 48 months. In some embodiments, the target period of time ranges from about 3 months to about 42 months. In other embodiments, the target period of time ranges from about 6 months to about 36 months. In still other embodiments, the target period of time ranges from about 9 months to about 30 months. In still other embodiments, the target period of time ranges from about 12 months to about 24 months.

The microbial consortium-including carrier powder may be included in the coated particle an amount of about 0.01 about 10 weight percent based on the total weight of the coated particle. In some embodiments, the microbe-containing carrier is included in an amount of about 0.05 to about 5.0 weight percent based on the total coated particle weight. In other embodiments, the microbe-containing carrier is included in an amount of about 0.1 to about 5.0 weight percent based on the total coated particle weight. In still other embodiments, the microbe-containing carrier is included in an amount of about 0.5 to about 1.5 weight percent based on the total coated particle weight. In yet other embodiments, the microbe-containing carrier is included in an amount of about 0.1 to about 1.0 weight percent based on the total coated particle weight. In other aspects, the amount of microbe-containing carrier that may be added ranges from about 0.2 percent to about 1.0 percent based on the total coated particle weight. In still other aspects, the amount of microbe-containing carrier that may be added may range from about 0.25 percent to about 0.75 percent (based on the total weight of the coated particle).

In some aspects, the amount of microbe-containing carrier may be determined based on the weight percent and/or thickness of the polymer coating, the desired length of time for degradation, and a combination thereof. For example, a coated particle with a coating thickness of about 5 μm to about 15 μm may include less microbe-containing carrier as compared to a coated particle with a coating thickness of about 20 μm to about 40 μm. Similarly, a coated particle with a coating weight of about 4 percent may include a higher concentration of microbe-containing carrier as compared to a coated particle with a coating weight of about 2-2.25 percent (based on the total weight of the coated particle). For instance, the coated particle with a coating weight of about 4 percent may include about 0.5 to about 0.75 percent of microbe-containing carrier as compared to about 0.15 to about 0.35 percent for a coated particle with a coating weight of about 2.25 percent (based on the total weight of the coated particle).

In other embodiments, a solution including the microbial consortium may be sprayed/applied onto the underlying particle or one or more coating layers. More specifically, as opposed to the microbe-impregnated carrier powder described above, the microbial consortium solution remains liquid for application. For example, such application may be particularly useful when a thin coating is applied for storage or compatibility purposes.

The coating method of the present disclosure provides several advantages over the prior art including, but not limited to, avoiding damage of the underlying particles and microbes or spores, faster reaction times, and no agglomeration of the particles.

### Finished Coated Particles

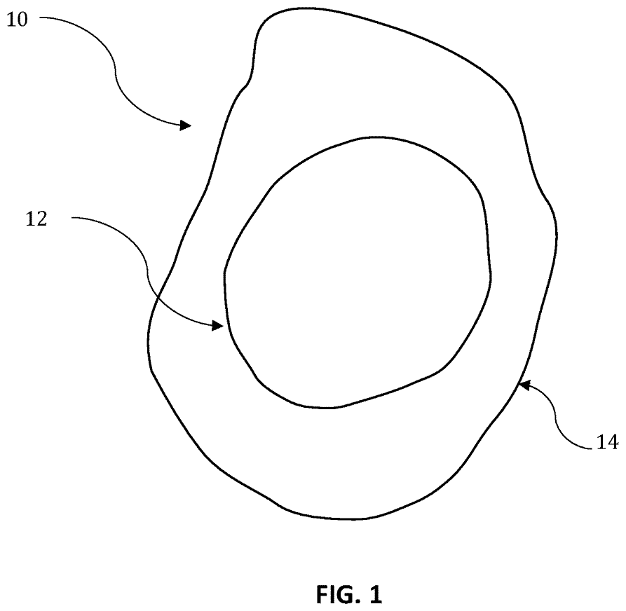

As shown in FIG. 1, a finished coated particle 10 include at least an underlying particle 12 and a protective coating layer 14 including multiple layers. In this aspect, the protective coating layer 14 may include one or more layers of cured and hardened polyol, polyisocyanate, and wax. The coating layer 14 may also include the carrier powder between the one or more layers of cured and hardened polyol. In some embodiments, the coating layer 14 applied in the second step in an amount of about 0.10 to about 20 weight percent, about 0.2 to about 15 weight percent, about 0.3 to about 10 weight percent or about 0.5 to about 5 weight percent based on the weight of the particle. If the second step, i.e., the coating step, is performed two or more times, these amounts refer to one instance of the second step. For example, if there are four coating layers, each individual coating level may be about 0.025 to about 5 weight percent, about 0.05 to about 3.75 weight percent, about 0.075 to about 2.5 weight percent about 0.125 to about 1.25 weight percent, based on weight of the underlying particle.

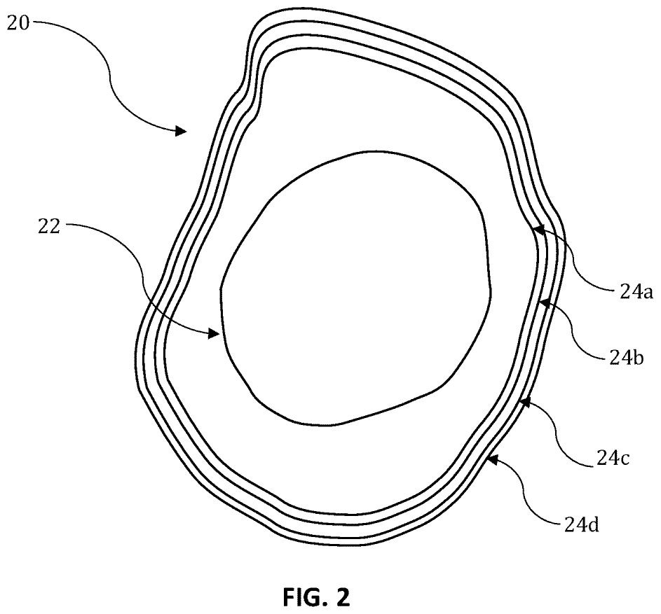

A cross-section of a finished coated particle with an underlying particle 22 and four layers 24a, 24b, 24c, and 24d is shown in FIG. 2. In some embodiments, the layer 24a is the carrier powder. In other embodiments, 24b is the carrier powder disposed between coating layers 24a and 24c and 24d is an additional coating layer disposed upon 24c. In still other embodiments, 24c is the carrier powder disposed between coating layers 24b and 24d and 24a is a coating layer disposed directly upon the uncoated particle 22. In yet other embodiments, 24d is the carrier powder disposed upon coating layers 24a, 24b, and 24c.

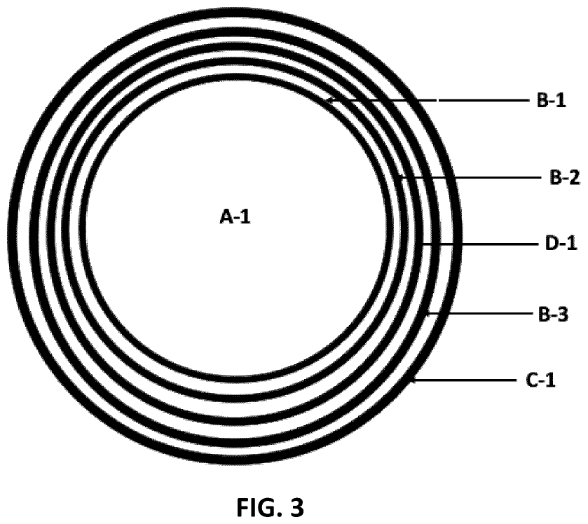

A cross-section of a finished coated particle in accordance with another embodiment is shown in FIG. 3. In one aspect, the coated particle includes underlying particle A-1, polyurethane and wax coating layers B-1, B-2, and B-3, polyurethane coating layer (with no wax sealant)C-1, and microbial consortium including carrier powder D-1.

The coated particles have a controlled release or controlled rupture rate depending on the underlying particle. For example, when the underlying particle is a fertilizer, the coating may slowly release the nutrients to a plant. More specifically, once water penetrates the coating, the fertilizer turns into solution and is forced out of the pores of the coating eventually leaving a residual (or empty) coating shell. The microbes are slowly released to the surface of the residual coating shell until all of the polymer in the coating shell has been degraded.

When the underlying particle is a seed, the coating may protect the seed until a predetermined time such that the seed has a longer period of dormancy than conventionally experienced. In fact, coated seeds in accordance with the present disclosure have an initial germination rate, i.e., the germination rate in the first growing season, that is comparable or better than the uncoated seed and also have a germination rate in the second growing season that is at least about 90 percent of the initial germination rate. In some aspects, the controlled rupture rate is based on the thickness or weight percent of the coating applied to the seeds. In this regard, the coated particles may have a rupture rate of at least about 20 days after planting in soil. In one embodiment, the coated seeds may have a delayed rupture/germination rate of at least about 90 days after planting in soil. In another embodiment, the delayed rupture/germination rate is at least about 120 day after planting in soil. In another embodiment, the delayed rupture/germination rate is at least about 150 days after planting in soil. In another embodiment, the delayed rupture/germination rate is at least about 180 days after planting in soil. In still another embodiment, the delayed rupture/germination rate is at least about 210 days after planting in soil.

The rupture rate may be further controlled for certain geographical areas. In this aspect, the thickness or weight percent of the coating may be adjusted for planting in different climates. In varying geographical areas, there are many factors that influence the timing and rate at which a seed germinates. For example, environmental factors such as the length of a growing season, the number of hours of sunlight in a day, the temperature of the soil, the soil type and mineral structure, the soil pH, and the soil moisture holding capacity all influence on seed germination. In addition, there are factors that could have a negative impact on the planted seeds during the desired dormancy period such as seed planting depth, excessive water/flooding (which could cause seed rot), wet freezing conditions (which could damage the seed protective membrane), seed parchment due to excessive heat, and/or soil insect attachment. The coating advantageously provides an insulating barrier for the seed against extreme weather conditions, guards against harmful insects, and protects the seed from moisture and/or freezing conditions, especially for seeds that are planted prior to the growing season, e.g., in late fall and winter. In this aspect, the coating on the seed would have a controllable rupture rate that promotes and/or facilitates germination in the primary growing season.

In this aspect, the coated particles of the present disclosure increase the dormancy of a seed (from planting in soil to germination) by at least about 70 percent as compared to the uncoated seed. In one embodiment, the dormancy of the seed is increased by at least about 80 percent over that of the uncoated seed. In another embodiment, the dormancy of the seed is increased by at least about 95 percent over that of the uncoated seed. Once the coated seed is ruptured and the seed germinates, the residual (or empty) coating shell remains. The present disclosure provides for the residual coating shell to be degraded by the microbes impregnated into the coating shell. More specifically, the microbes are slowly released to the surface of the residual coating shell until all of the polymer in the coating shell has been degraded.

### EXAMPLES

The following example does not limit the invention or the claimed subject-matter. Rather, the example is intended to further illustrate an embodiment of the present disclosure.

### Example 1: 4 Percent Polymer Coated Urea Containing 0.25 Percent Microbe-Containing Carrier Powder

A high-speed mixer/coater was preheated to an approximate temperature of 50° C.-65° C. During preheating, the rotating container and rotor were operated in the clockwise direction at 6.00 m/s and 1.95 m/s, respectively. Once preheated, the mixer was charged with 4536 g of uncoated urea with an average particle diameter of 3.0-3.5 mm. The uncoated urea was allowed to preheat to a temperature of approximately 65° C.-70° C. Once this preheat was achieved, the mixer parameters were adjusted for the coating process. The rotating pan operated in the clockwise direction at a speed of 12.00 m/s, while the rotor operated in the counterclockwise direction at a speed of 6.00 m/s. The mixer was then charged with 15.9 g polyol, allowed to mix for 30 seconds, and then charged with 25.6 g of isocyanate. After these components were allowed to roll and react for 60 seconds, a 7.9 g charge of molten wax was added and allowed to roll an additional 30 seconds. The polyol, isocyanate and wax addition steps and mixing times were repeated a second time before 11.8 g of diatomaceous earth/microbe powder was charged to the mixer/coater. The carrier powder was allowed to mix for 45 seconds before a third charge of polyol, isocyanate and wax were applied and cured for 60 seconds. The final outer coating layer was applied by first adding polyol to the mixer/coater, waiting 30 seconds, and applying isocyanate, followed by a 60 second roll time. Once the coating process was complete, ambient air was used to cool the coated fertilizer to approximately 35° C.

### Example 2: 4 Percent Polymer Coated Urea Containing 0.75% Microbe-Containing Carrier Powder

A high-speed mixer/coater was preheated to an approximate temperature of 50° C.-65° C. During preheating, the rotating container and rotor were operated in the clockwise direction at 6.00 m/s and 1.95 m/s, respectively. Once preheated, the mixer was charged with 4536 g of uncoated urea with an average particle diameter of 3.0-3.5 mm. The uncoated urea was allowed to preheat to a temperature of approximately 65° C.-70° C. Once this preheat was achieved, the mixer parameters were adjusted for the coating process. The rotating pan operated in the clockwise direction at a speed of 12.00 m/s, while the rotor operated in the counterclockwise direction at a speed of 6.00 m/s. The mixer was then charged with 15.9 g polyol, allowed to mix for 30 seconds, and then charged with 25.7 g of isocyanate. After these components were allowed to roll and react for 60 seconds, a 7.9 g charge of molten wax was added and allowed to roll an additional 30 seconds. The polyol, isocyanate and wax addition steps and mixing times were repeated a second time before 35.7 g of diatomaceous earth/microbe powder was charged to the mixer/coater. The carrier powder was allowed to mix for 45 seconds before a third charge of polyol, isocyanate and wax were applied and cured for 60 seconds. The final outer coating layer was applied by first adding polyol to the mixer/coater, waiting 30 seconds, and applying isocyanate, followed by a 60 second roll time. Once the coating process was complete, ambient air was used to cool the coated fertilizer to approximately 35° C.

The specifications and performance of Examples 1 and 2 were tracked and recorded in Table 1. The coating weight and carrier powder amounts are percentages based on the total weight of the final coated particles. The procedure for determining the rate of nutrient release was as follows:
1. Nutrient standard solutions were prepared by dissolving a variety of known concentrations of nutrients in distilled water.
2. The refractive index of the known concentrations is measured with a refractometer to develop a calibration curve of refractive index vs. concentration.
3. Next, 10 g of coated fertilizer particles is accurately weighed into a small jar and 100 g of water is added.
4. The sample is gently swirled and placed in a 22° C. lab oven for a pre-determined period. Before each measurement, the sample is gently swirled to ensure uniformity. A small sample of the solution from the sample jar is placed on the refractometer, and the measurement recorded.
5. Comparison to the calibration curve gives the nutrient concentration in the solution. The percentage of nutrient released from the coated fertilizer particles is calculated.

| Product Description | | | | | | | | | | |
|---|---|---|---|---|---|---|---|---|---|---|
| | | | Microbe | | | | | | | |
| | | | Carrier | Nutrient Release Rate (%) at 22° C. | | | | | | |
| | Fertilizer | Coating | Powder | 7 | 14 | 21 | 28 | 35 | 42 | 49 |
| Example | Core | (%) | (%) | Day | Day | Day | Day | Day | Day | Day |
| 1 | Urea | 4.0 | 0.25 | 2.7 | 5.7 | 9.9 | 14.7 | 18.1 | 21.4 | 25.87 |
| 2 | Urea | 4.0 | 0.75 | 6.1 | 13.3 | 19.6 | 28.1 | 33.0 | 37.8 | 43.84 |

The thickness of the coating in Examples 1 and 2 is about 27 μm.

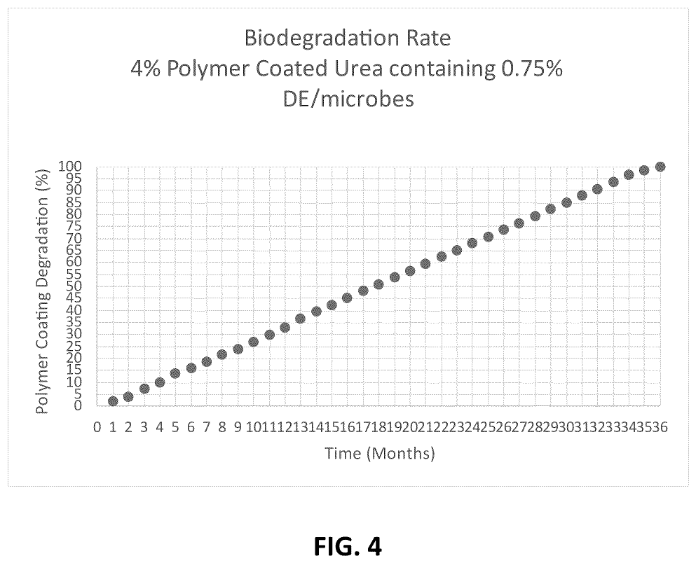

Visual observations of empty coating shells demonstrated degradation of the empty shells within a matter of weeks after the particle would have been released to the plant. Example 1 has complete degradation of the polymer coating in 48 months or less. As shown in FIG. 4, Example 2 has over 30 percent degradation of the polymer coating at 12 months, more than 65 percent degradation of the polymer coating at 24 months and complete degradation of the polymer coating in 36 months.

### Example 3: 2.25 Percent Polymer Jacket-Coated Calcium Nitrate Containing 0.25 percent Microbe-Containing Carrier Powder

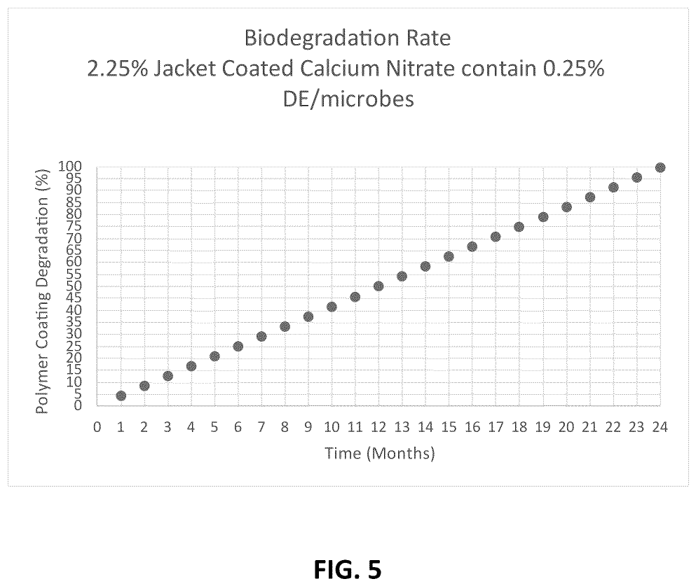

Using a similar process as in Example 1, calcium nitrate was jacket-coated, i.e., a relatively thin coating (as compared to Examples 1 and 2) was applied for storage purposes, blending compatibility, or a combination thereof. In this aspect, a high-speed mixer/coater was preheated to an approximate temperature of 50° C.-65° C. During preheating, the rotating container and rotor were operated in the clockwise direction at 6.00 m/s and 1.95 m/s, respectively. Once preheated, the mixer was charged with 4536 g of uncoated calcium nitrate with an average particle diameter of 3.0-3.5 mm. The uncoated calcium nitrate was allowed to preheat to a temperature of approximately 55° C.-65° C. Once this preheat was achieved, the mixer parameters were adjusted for the coating process. The rotating pan operated in the clockwise direction at a speed of 12.00 m/s, while the rotor operated in the counterclockwise direction at a speed of 6.00 m/s. The mixer was then charged with 13.4 g polyol, allowed to mix for 30 seconds, and then charged with 21.5 g of isocyanate. After these components were allowed to roll and react for 60 seconds, a 11.6 g charge of molten wax was added and allowed to roll an additional 30 seconds. Next 11.6 g of diatomaceous earth/microbe powder was charged to the mixer/coater. The carrier powder was allowed to mix for 45 seconds before a final outer coating layer was applied by first adding polyol to the mixer/coater, waiting 30 seconds, and applying isocyanate, followed by a 60 second roll time. Once the coating process was complete, ambient air was used to cool the coated calcium nitrate to approximately 35° C. The thickness of the jacket coating in Example 3 is about 12 μm. As shown in FIG. 5, Example 3 has about 50 percent degradation of the polymer coating at 12 months, more than 70 percent degradation of the polymer coating at 18 months and complete degradation of the polymer coating in 24 months. In comparing FIGS. 4 and 5, the coated particle in Example 2 requires about 5 months more (around 17 months) to achieve about 50 percent degradation as compared to Example 3.

What is claimed is:

1. A coated particle comprising:
a core; and
a coating shell comprising:
a first coating layer disposed on the core comprising a coating formulation and a wax;
a carrier impregnated with a microbial consortium, wherein the carrier is applied to the first coating layer in an amount of about 0.1 to about 1.0 percent by weight of the coated particle; and
a second coating layer disposed on the carrier comprising the coating formulation, wherein the coated particle has a functionality period, and wherein the microbial consortium comprises a plurality of microbes capable of substantially biodegrading the coating shell in a target period of time, wherein the target period time is about 48 months or less after the end of the functionality period.

2. The coated particle of claim 1, wherein the core comprises a fertilizer.

3. The coated particle of claim 1, wherein the core comprises a seed.

4. The coated particle of claim 1, wherein the coating formulation comprises polyurethane.

5. The coated particle of claim 4, wherein the polyurethane is the reaction product of a polyisocyanate and a polyol.

6. The coated particle of claim 5, wherein the plurality of microbes comprises a first set of microbes capable of degrading the coating formulation and a second set of microbes capable of degrading the wax.

7. The coated particle of claim 1, wherein the plurality of microbes comprises least two or more microbes classified as Bio-Safety Level 1 organisms.

8. The coated particle of claim 1, wherein the coating shell further comprises:
a third coating layer disposed between the first coating layer and the carrier, and comprising the coating formulation and a wax; and
a fourth coating layer disposed between the carrier and the second coating layer and comprising the coating formulation and a wax.

9. The coated particle of claim 1, wherein the carrier is a powder.

10. A coated particle comprising:
a core;
a carrier impregnated with a microbial consortium, wherein the carrier is applied to the core; and
a coating shell comprising:
a first coating layer comprising a coating formulation and a wax and disposed on the carrier; and
a second coating layer comprising the coating formulation and disposed on the first coating layer,
wherein the coated particle has a functionality period, and wherein the microbial consortium is capable of substantially degrading the coating shell in about 48 months or less after the end of the functionality period.

11. The coated particle of claim 10, wherein the core comprises a fertilizer.

12. The coated particle of claim 10, wherein the core comprises a seed.

13. The coated particle of claim 10, wherein the coating formulation comprises polyurethane.

14. The coated particle of claim 13, wherein the microbial consortium comprises a first set of microbes capable of degrading the coating formulation and a second set of microbes capable of degrading the wax.

15. The coated particle of claim 14, wherein the carrier is a powder.

16. A coated particle comprising:
a core; and
a coating shell comprising:
a first coating layer disposed on the core and comprising the coating formulation; and
a carrier powder disposed on the first coating layer and impregnated with a microbial consortium, wherein the coated particle has a functionality period, wherein the microbial consortium comprises a plurality of microbes capable of substantially degrading the coating shell in a target period of time, and wherein the target period of time is about 48 months or less after the end of the functionality period.

17. The coated particle of claim 16, wherein the core comprises a fertilizer.

18. The coated particle of claim 16, wherein the core comprises a seed.

19. The coated particle of claim 16, wherein the coating formulation comprises polyurethane.

20. The coated particle of claim 19, wherein the polyurethane is the reaction product of a polyisocyanate and a polyol.

21. The coated particle of claim 19, wherein the plurality of microbes comprises a first set of microbes capable of degrading the coating formulation and a second set of microbes capable of degrading the wax.

22. The coated particle of claim 16, wherein the plurality of microbes comprises at least two microbes classified as Bio-Safety Level 1 organisms.
